(19) United States
(12) Patent Application Publication
(10) Pub. No.: US 2008/0263585 A1
(43) Pub. Date: Oct. 23, 2008

(54) SYSTEM AND METHOD FOR ON-LINE VIDEO DEBATING

(76) Inventors: Richard Gell, Garrison, NY (US); Todd Pavlin, New York, NY (US)

Correspondence Address: OSTROLENK FABER GERB & SOFFEN, 1180 AVENUE OF THE AMERICAS, NEW YORK, NY, 100368403, US

(21) Appl. No.: 11/763,892

(22) Filed: Jun. 15, 2007

Related U.S. Application Data
(60) Provisional application No. 60/813,839, filed on Jun. 15, 2006.

(51) Int. Cl. H04N 7/10

(52) U.S. Cl. 725/32

(57) ABSTRACT

A method and system for electronically providing a debate of at least two viewpoints is provided herein. Preferably, at least a first party having a first viewpoint and a second party having a second viewpoint are defined, wherein the first party and the second party participate in the debate. Moreover, rules of the debate are defined that the at least first party and second party agree to follow. Additionally, a first electronic transmission representing the first viewpoint is received from the first party, and a second electronic transmission representing the second viewpoint is received from the second party. The rules of the debate are electronically enforced with respect to the first electronic transmission and the second electronic transmission, and modifying the transmission(s) in case at least one of the transmissions does not comply with the rules of the debate. Further, a third electronic transmission is received from a third party that represents factual challenge, multimedia content supporting the first viewpoint or the second viewpoint, and/or commentary. Moreover, the first, second and third electronic transmissions are accessible to viewers over a communication network.

### CROSS-REFERENCE TO RELATED APPLICATIONS

This application is based upon and claims priority to U.S. Provisional Patent Application Ser. No. 60/813,839, filed on Jun. 15, 2006 and entitled SYSTEM AND METHOD FOR ON-LINE VIDEO DEBATING, the entirety of which is incorporated herein by reference.

### BACKGROUND OF THE INVENTION

1. Field of the Invention

The present invention relates generally to communications and, more particularly, to interactive communications over the internet.

2. Description of the Related Art

Many forms of debate remain an integral part of human interaction. For example, sports fans, neighbors, presidential candidates, students, lawyers and television pundits argue and discuss topics face to face, on the radio, on the telephone, on broadcast television, cable and, more recently, over the internet. Accordingly, documentaries, reality programming and political short films have increasingly become revenue drivers, as political film production remains a growing industry and implemented in a wide range of people from amateurs to the biggest names in Hollywood.

One reason for the success and growth in connection with political programming is that advances in technology, particularly related to computers, enables low production costs for political short films, documentaries, music videos, public service announcements and advertisements. Various media related to political programming are produced each year for web sites, film festivals, non-profits, film schools, political organizations and media companies. Currently, a large majority of internet web sites that provide political content are non-profit, are directed to one or more respective issues, and are typically provide content in the form of text, some commercial internet web sites present political short films as a relatively small part of their overall programming.

In a typical prior art television debate, the participant who screams the loudest, talks the fastest and monopolizes the microphone often wins. Political candidates and college debating teams often negotiate and adhere to fair and even “rules of engagement” for live debates. Unfortunately, however, no system has been created that provides an electronic process to enforce such rules for video debates. Moreover, no system currently exists for individuals or groups that are in remote locations to participate in debates, particularly at different times.

Relatively recently, the internet and new technologies enable individuals to record and post video segments for replay around the world. Further, television viewers are provided new technology to fast-forward or rewind a show substantially in real time. With the advent of DVD, viewers are able to choose “segments” of a video and watch out of chronological order. Thus, opportunities for individuals to publish video content over the Internet and to manipulate video have increased.

In one known system, a web site, BLOGGINGHEADS.TV, simultaneously displays two pundits who sit in front of their computers and, using web-cams, debate a topic. Typically, the debate is archived and displayed at some time in the future after the debate occurred. In another example, a popular animation, “This Land” and provided by the web site, JIBJAB.COM, generated over 50 million downloads before the 2004 election. In yet other examples, some internet web sites currently play news programming, commercials, video news releases, or the like, and post written commentary thereabout. An example of such web sites includes MEDIAMATTERS.ORG and CROOKSANDLIARS.COM.

In spite of the abundance of political and socially conscious media outlets, such as internet web sites, television and radio broadcast, no prior art system exists that facilitates virtual, online video debates that can take place over a plurality of days.

### SUMMARY

Accordingly, a method and system for electronically providing a debate of at least two viewpoints is provided herein. Preferably, at least a first party having a first viewpoint and a second party having a second viewpoint are defined, wherein the first party and the second party participate in the debate. Moreover, rules of the debate are defined that the at least first party and second party agree to follow. Additionally, a first electronic transmission representing the first viewpoint is received from the first party, and a second electronic transmission representing the second viewpoint is received from the second party. The rules of the debate are electronically enforced with respect to the first electronic transmission and the second electronic transmission, and modifying the transmission(s) in case at least one of the transmissions does not comply with the rules of the debate. Further, a third electronic transmission is received from a third party that represents factual challenge, multimedia content supporting the first viewpoint or the second viewpoint, and/or commentary. Moreover, the first, second and third electronic transmissions are accessible to viewers over a communication network.

Other features and advantages will become apparent from the following description that refers to the accompanying drawings.

### BRIEF DESCRIPTION OF THE DRAWING(S)

For the purpose of illustration, there is shown in the drawings a form which is presently preferred, it being understood, however, that the invention is not limited to the precise arrangements and instrumentalities shown. The features and advantages of the descriptions herein will become apparent from the following description that refers to the accompanying drawings, in which:

FIG. 1 shows an example internet home page display screen that is preferably provided to a visitor to a web site in accordance with the teachings herein;

FIG. 2 shows an example display screen that is provided to a user who selects debate of the week;

FIGS. 3A-3C illustrate example display screens of video segments according to a preferred embodiment;

FIG. 4 shows an example display screen that is provided to a user who desires to view archived video content in accordance with an embodiment;

FIG. 5 illustrates an example display screen that is provided to a user who selects a particular category of video content;

FIG. 6 shows an example display screen that is provided to a user who selects a particular video in connection with the category shown in FIG. 5;

FIG. 7 is an example data entry form that is provided to a registered user who desires to participate in a debate in accordance with the teachings herein;

FIG. 8 illustrates an example display screen that is provided to a user for reviewing tabulated vote counts associated with a respective video debate; and

FIG. 9 shows an alternative example internet home page display screen that is preferably provided to a visitor and directed to a debate associated with sports-related content.

### DESCRIPTION OF THE EMBODIMENTS

Preferably a comprehensive system and method is provided herein for enabling users to create, review, archive, host, view and/or distribute video debate segments. Preferably, the segments are provided in a digital format, are available on the internet and can be provided on various devices, such as personal playing systems (e.g., IPOD), televisions, computers, or any other electronic medium known in the art. Preferably the video segments are provided for virtually any topic, in any language and in any location.

In an embodiment, various forms of media are legally provided from remote providers, such as provided with permission by a respective third-party copyright owner, and preferably used to garner commentary. In an embodiment, recorded commentary is provided in various forms. For example, commentary may be formatted as a digital movie clip, a work of art, a news segment, a television show, a documentary, a song, a speech, a public service announcement, political commercial, podcast, corporate production, home movie, government or military films, or any other content in a web site. Thus, any media format or source may be employed, and may be provided via a hyperlink in an internet web site. By providing links to commentary, a host internet web site is enhanced, for example, by commentators or viewers that review, post, and comment on specific video segments.

Moreover, commentary may be associated with a respective video segment, such as to utilize various internet functionality, as known in the art, including to post, review, add and/or edit metadata representing the video segment and/or commentary. Further, video segments and supplementary text, audio, graphics and video may be associated via metadata.

In an embodiment, a viewer watches video segments with accompanying textual and graphical feature support, including, for example, via a second display screen. Other available features include a contribution by a third party, referred to herein as a “friend of a debate,” or to challenge a respective factual assertion. In one context, a friend of a debate may include debaters or commentators chosen by a primary debater or commentator to provide supplementary commentary or debate. In one embodiment, friends of a debate are pre-approved by all principal parties to a debate and provide expert testimony, eyewitness testimony, anecdotal support, humorous or other perspectives or support to a topic of debate or commentary. Preferably, such contributions may be provided in a particular time sequence during a live broadcast, or may be archived for convenient review at any time.

Thus, a unique and original system and process is provided that preferably links video segments for interactive debate and commentary that are viewable in a “live,” substantially real-time format. Alternatively, or in addition, debate and commentary may be pre-recorded.

Preferably, methods for controlling and linking recordings, as well as for delivering video segments, or for providing data functionality such as defining metadata, storing video segments, downloading, streaming and/or archiving video segments related to a specific topic of debate or commentary are preferably provided. Any stage in electronic media whereby electronic hardware or software is used to facilitate recording, conversion or capture of electronic media from one source to another is similarly supported or provided herein. For example, a video camera, recordable media inside a camera (e.g., tape, film, or digital storage device), wire connected to a recording device or the like are supported and/or provided in accordance with the teachings herein.

In a preferred embodiment, video segments of two or more viewpoints or “sides” of a video debate are coordinated and/or controlled to allow for community voting as well as community participation by linking to or hosting video segments supplied by viewers. Further, video segments are preferably facilitated by journalists, experts, commentators, citizens, celebrities, politicians, sports figures, or the like, generally referred to herein as “talent.” The systems and methods described herein facilitate video segments in a new and useful manner for debate and/or commentary. In an embodiment, webcam technology, as known in the art, is used. Alternatively, teleconferencing or other satellite, broadcast or web-based delivery, or the physical delivery of digital or analog tapes, or any future improved technology can be used. This is a useful and unique business process, and the system is designed openly to absorb and integrate future ingest technologies that simplify the ingest process.

In an example operation, debaters, commentators, friends of a debate and/or viewers access an internet web page on a site and enter a specific access code, provided by the host web site to obtain authorized access. Thereafter, the authorized user is provided with instructions to perform various operations, such as to record, edit and/or transmit a video segment or segments, corresponding text, audio or graphics, and/or any factual challenges, in accordance with mutually agreed upon rules of the debate (occasionally shown in the drawings and/or referred to as “rules of engagement”). In an alternative embodiment, any otherwise unauthorized visitor may post debate or third party media comments on a particular topic or media without adhering to particular rules or without submitting an authorization code.

Preferably, any file format is supported. Moreover, live segments may be recorded directly from the site or recorded video in any format may be uploaded or otherwise ingested. For example, video debate segments may be recorded via a web-cam, home video equipment, a teleconferencing studio, remote recording technology on location, via satellite or a professional studio with video recording, broadcast, broadband, fiber optic, satellite or any future recording or delivery capabilities.

Preferably, known web-cam recording hardware and software technology, such as VLOG IT!, or other proprietary technology may be employed. In any event, known technology is preferably used that is current and flexible. Known systems are preferably used that accommodate state of the art and efficiently record and deliver systems for video, audio, graphics and text for example, as provided on the world wide web, by software or hardware developers or other communications networks.

Further, web video programming is supported, for example, to be viewed on home televisions, computers, IPODS and other portable devices. For example, SLINGBOX and TIVO are provided in embodiments to further delivery of video segments.

In an embodiment, posted video segments are stored in an electronic “holding zone.” In this way, video segments are approved before the segments are posted to a publicly viewable area. In an alternative embodiment, video segments are posted without any pre-approval, thereby enabling debaters, commentators, friends of the debate or viewers to post video segments directly to a site without approval.

As noted above, rules are provided to allow a host site or debaters to adhere to, adjust and/or add new rules for debate. Preferably, a range of options from live to pre-recorded variable length video segments and delivery dates are accommodated. Also, preferably, various features are provided to allow for the following rules of engagement. For example, video segments may be provided “live” and substantially in real-time, or may be pre-recorded. Other features include supporting on-line elections so viewers may vote for a winner of the debate, enabling a debate challenge, including or excluding a mediator or moderator, controlling one or more debaters on respective sides of a debate, and for receiving live or pre-recorded questions to be answered by debaters. Moreover, video segments may be altered to vary the length and number of segments, or to otherwise enable debaters to edit video segments. Other features include establishing deadlines, including start dates and end dates for submission of segments.

Moreover, are preferably established to allow for fact challenges, to permit contributions by a friend of the debate, to add/edit content that complies with pre-established length and content rules. Further, metadata may be defined by debater, or by various techniques, such as voice recognition, closed captioning, or entered by a third party. Rules preferably allow community involvement in debates beyond merely voting via posting of video, audio, graphic or text segments. For example, prizes may be awarded for winners of debates, and advertisers, sponsors, host sites or other third parties can post segments before, on or around segments or even entire debates. In this way, display screens are adjustable to expand and contract, and instant viewing of a segment of the debate as a preview is similarly supported. Preferably, a dynamic ability for screens to expand and contract, either automatically in sequence as the debate progresses via the linking of segments, or on any individual segment as chosen by a viewer of the debate or commentary is provided. This makes for a more pleasurable viewing experience for the viewer.

In one embodiment, a live debate is recorded using features described herein, much like a typical live television broadcast of a debate. Thus, the debate is broadcast over the internet, as known in the art, or otherwise broadcast on television and/or radio or other known way. Thereafter, the debate is provided as a video segment and, optionally, enhanced or viewed at a later date. In this embodiment, a single debate can take place over many days or weeks. Each individual segment may be webcast or broadcast live, and, thereafter, archived and available for viewing in the future.

In an alternative embodiment, video debate, to take advantage of the full functionality, as described herein, include debaters who remotely record their video segments via web-cam cameras and thereafter, “post” the video to the site provided and/or hosted in accordance with the teachings herein.

In one embodiment, votes are received in a debate election and tabulated, either by approved subscribers or members of a particular host site or viewers at large, to determine winners of individual segments as well as winners of an entire debate.

Preferably, a “challenge” may be issued to an individual, group of individuals or organization. The challenge can be in the form of a video segment, with suggested rules of engagement, or cash prize, that can be posted on a host site or delivered to third party sites or media organizations. An individual host site or individual or group may want to chose a debate topic and publicly offer to debate another individual or group of individuals, or act as a host and sponsor. They may chose to offer a cash reward or prize and suggest rules of engagement. This would constitute a challenge and the are preferably ingest, hosting and viewing of such a challenge on a site in accordance with the teachings herein are accommodated.)

Another feature includes an accommodation of a moderator, no moderator or questions to be posed by debaters or third parties. In case a moderator is included, debates may be presented in a live or pre-recorded format. If a moderator is chosen in a live video debate, segments may be broken down according to each question posed by the moderator for future playback. In a pre-recorded debate the rules of engagement are accommodated to coordinate when moderator questions are electronically delivered to debate participants and posted, for example, on a web site.

In case no moderator is included, debaters preferably pose questions to each other in respective individual segments, or may otherwise agree in rules of engagement to answer questions posed by third parties. Such third-party questions may come from an audience for a debate, be posted on a web site, submitted by letter or email or from a sponsor, advertiser, viewer, visitor or host at the site.

Further, live or recorded questions may be provided in any format, e.g., video or text, and metadata may further be added, via voice recognition software, closed captioning or loggers to create fully searchable text versions of the questions raised by moderators, debaters or third parties.

Also in an embodiment, a pre-determined number of participants representing various viewpoints of a debate is provided. The participants may be matched in various ways, such as individual versus individual, group versus group, individual versus group, or the like. Alternatively, no matching restrictions are imposed. Furthermore, multiple debaters may be accommodated to individually debate. Moreover, and as noted above, any number of video segments and segment lengths are accommodated. Segments can be of different lengths throughout the debate.

Debaters preferably mutually agree to deadlines for delivery and posting of video segment or, if “live,” when the webcast/broadcast of a video segment or entire debate will take place. A typical debate will involve one new segment a day, but some video debaters may prefer a more rapid pace, which is preferably accommodated.

In an embodiment and to facilitate any one debater complying with predetermined time limitations, and/or to improve the synchronization of additional supporting materials or fact challenges (such as displayed in an additional display) various known editing capabilities are provided. As described herein, a second display screen provided in a designated area on a site, for example, via a TV, computer or IPOD monitor, or the like is utilized by the debater to provide supplementary visual support while the debater are speaking. This second display screen preferably accommodates textual, graphical, video and/or audio content that the debater chooses to present. Editing functionality allows the debater to coordinate and edit the various content to synchronize effectively with a respective debate segment.

In one embodiment, a “pop up” window (as known in the art) preferably is displayed in case a factual challenge as posed by a debater. Preferably, parties of a debate mutually agree to allow such pop up windows to be displayed. Preferably, pop up windows representing factual challenges represent a supplement to retorts and challenges provided within various debate segments. Preferably, fact challenges are provided in various forms, such as a textual display, a hyperlink to a web site, or a video segment provided by an expert. Preferably, fact challenges are linked to a specific time-coded moment in an opposing debater's video segment.

As noted herein, a second display screen preferably is provided that allows debaters to edit and post at specific time-coded moments in their video segments supporting video, data, charts, links, graphs, text, music, animation. Preferably, debaters mutually agree to the use of the second video screen. Depending upon current technology, two or more screens of support material along with the core video debate segment are preferably displayed simultaneously. As noted above, the second display screen preferably expands and contracts in size according to the mutually agreed to rules of engagement.

Also, in a preferred embodiment, the visual division of a web site or broadcast screen into two areas, referred to herein, generally, as “electronic turf,” is controlled by the two or more debating parties. Using sophisticated internet-based technology, participants in a debate may choose allow debaters to utilize equal space on a web site to post any combination of video, graphics, text, audio or links to support a respective argument. The electronic turf preferably allows video debaters to expand and improve the display of their postings. The only limit to the production value and sophistication of the segment postings comes from the participants themselves. Preferably, a limitless number of video segments that support the arguments of a particular debater are provided.

In one embodiment, a debate may be available for viewing and interaction within the entire web community. For example, links may be posted to video segments stored on third party web sites, podsites, TIVO cable channels or other known storage media. Viewers' experiences are preferably enhanced via an option to view friends of debate segments simultaneously with a debater's corresponding segment or, alternatively, at a later time subject to the viewers' discretion.

Preferably, accommodated is a virtually limitless number of video postings and/or links to web sites for comments by viewers or organizations. In this way, a sort of electronic hub is provided for electronic discussion of a debate topic or third party media commentary chosen by a host site.

In another embodiment, a segment of third party media and responses is judged by a panel of experts or voted upon by viewers to determine winners of a debate. The viewers are preferably awarded cash and/or other prizes. The amount and/or value of a prize is preferably determined by the site, sponsor and/or participants in the debate.

Another feature of a preferred embodiment includes instant viewing, such as the known SPEEDVIEW product, provided by THOUGHT EQUITY or alternatively, any other known application that allows video segments to play instantly when a selection device, such as a mouse cursor, passes over a still image representing a video segment. Preferably, a playback of a short “highlight” from a respective segment occurs instantly as the cursor passes over the video image of a particular segment. Moreover, full segments preferably play instantly, such as by utilizing FLASH or other technology.

Another feature of the system and method provided herein is an ability to link video segments of debaters, friends of the debate and/or fact challenges to allow the viewer to view segments, for example, linked according to various criteria. For example, video segments may be linked by subject matter, time sequence, or in accordance with other individually defined rules that are established for a respective video debate. Preferably, options for posting, linking and viewing are provided in a flexible way to viewers. For example, a viewer may choose to start watching a particular video debate at the beginning, in the middle or closing statements along with any supplemental and supporting linked segment. In a preferred embodiment, video segments preferably have a separate frame grab, as known in the art, posted on the site, with appropriate metadata attached to allow viewers to chose where they want to begin. Furthermore, options for posting, linking and viewing is provided for commentator-related content as debaters-related content. In this way, a viewer has the same ability to start viewing commentary at the beginning, middle or end of a respective commentary segment.

Additionally, viewers are preferably provided options to post amateur and/or original content. Thus, community involvement is preferably supported by the teachings herein.

Moreover, video debate segments that are submitted by viewers are subject to votes by other viewers. This allows for a host site to either post the segments randomly, chronologically by submission date or according to popularity as determined by mutually agreed upon judges or by visitors to the web site or viewers.

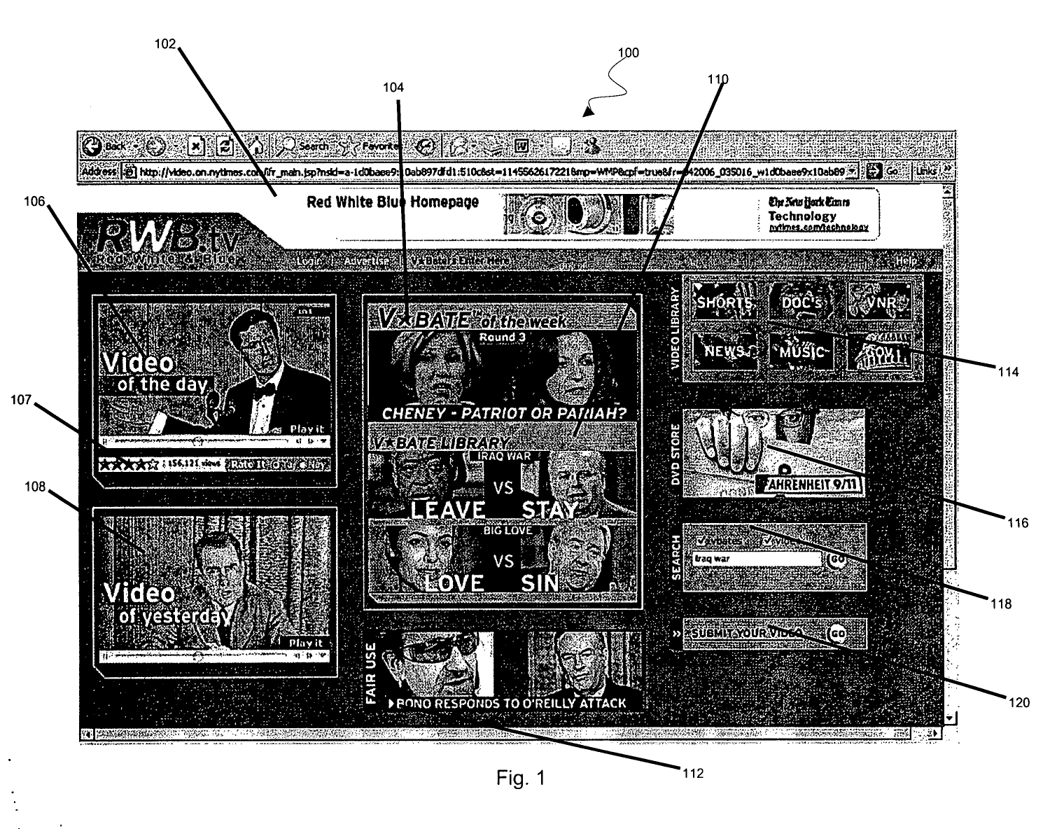

Referring now to the reference figures, in which like reference numerals refer to like elements, FIG. 1 shows an example internet home page display screen 100 that is preferably provided to a visitor to a web site 102 in accordance with the teachings herein. Preferably, the various controls 102-120 are formatted as selectable controls (e.g., hyperlinks), or contain selectable graphical screen controls, such as checkboxes, textboxes, drop-down lists, push buttons or the like.

Continuing with reference to FIG. 1, video debate (displayed as “V*Bate”) of the week 104 features Mary Matalin, advisor to Dick Cheney, versus Maureen Dowd, columnist for the New York Times, who agree to a debate entitled: Cheney—Pariah or Patriot. Other features shown in display screen 100 include video of the day section 106, video of yesterday feature 108, archived video segment library 110 and data archive 112. Furthermore, rating 107 is provided for viewers to receive feedback regarding the video of the day 106. Video library section 114 includes selectable options for short films, documents, video news releases, news data, music and government data. Also included in example display screen 100 and shown in Fig. are DVD store 116 for purchasing DVDs, search box 118 for locating a video debate and/or video, and upload option 120 for uploading video content.

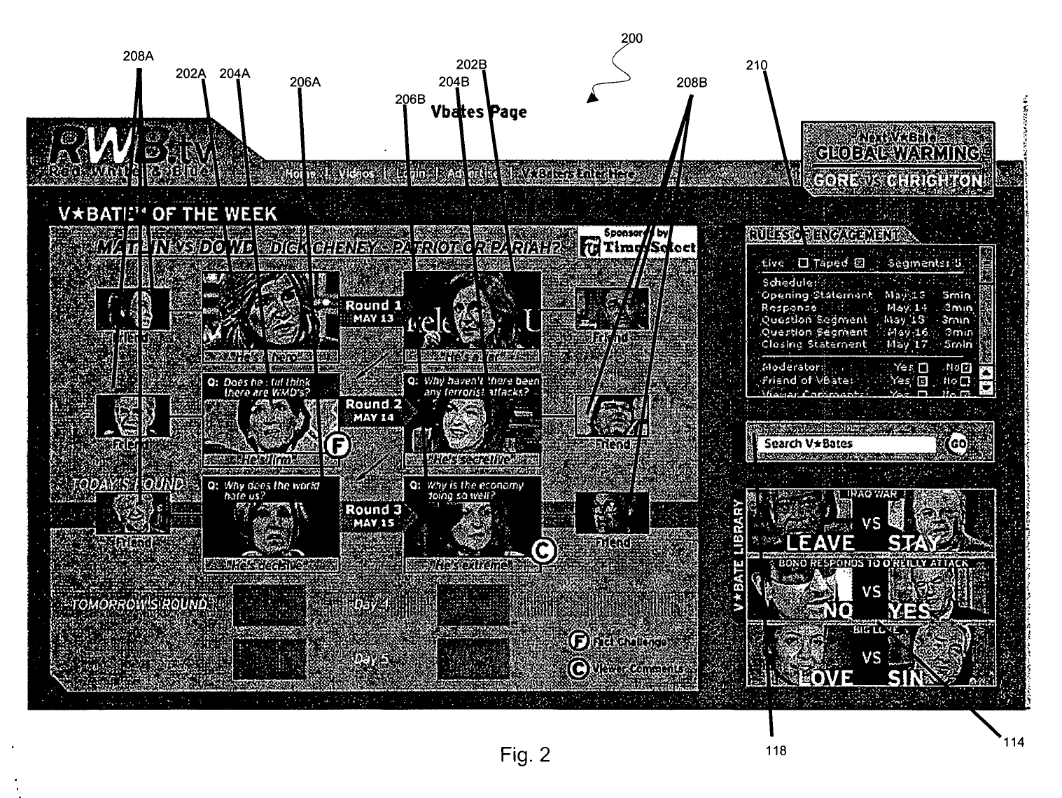

FIG. 2 shows an example display screen 200 that is provided to a user who selects debate of the week 104 (FIG. 1). Example display screen 200 includes selectable video debates that are provided in connection with the selected video debate 104. Preferably, and as shown in FIG. 2, both sides of each day's debate are selectable. More particularly, video selections 202A, 204A and 206A feature the first party, Mary Matalin, in each respective video round, while video selections 202B, 204B and 206B feature the second party, Maureen Dowd, similarly in each respective video round. By presenting respective selectable links directed to each party's video segment, a viewer has flexibility in viewing a video debate. Also shown in FIG. 2 are selectable links to friends of the debate 208A and 208B, that enable the viewer to watch postings from friends of the debate for the respective parties.

Continuing with reference to example display screen 200 shown in FIG. 2, both parties negotiate and agree to rules of engagement 210 and choose to record and post their segments via web cams, start the debate on May 13^{th} and post one video segment per day for five days. Furthermore, the debate carries no vote or prizes, and one friend of the debate 208A/B and one fact challenge are allowed per debate segment.

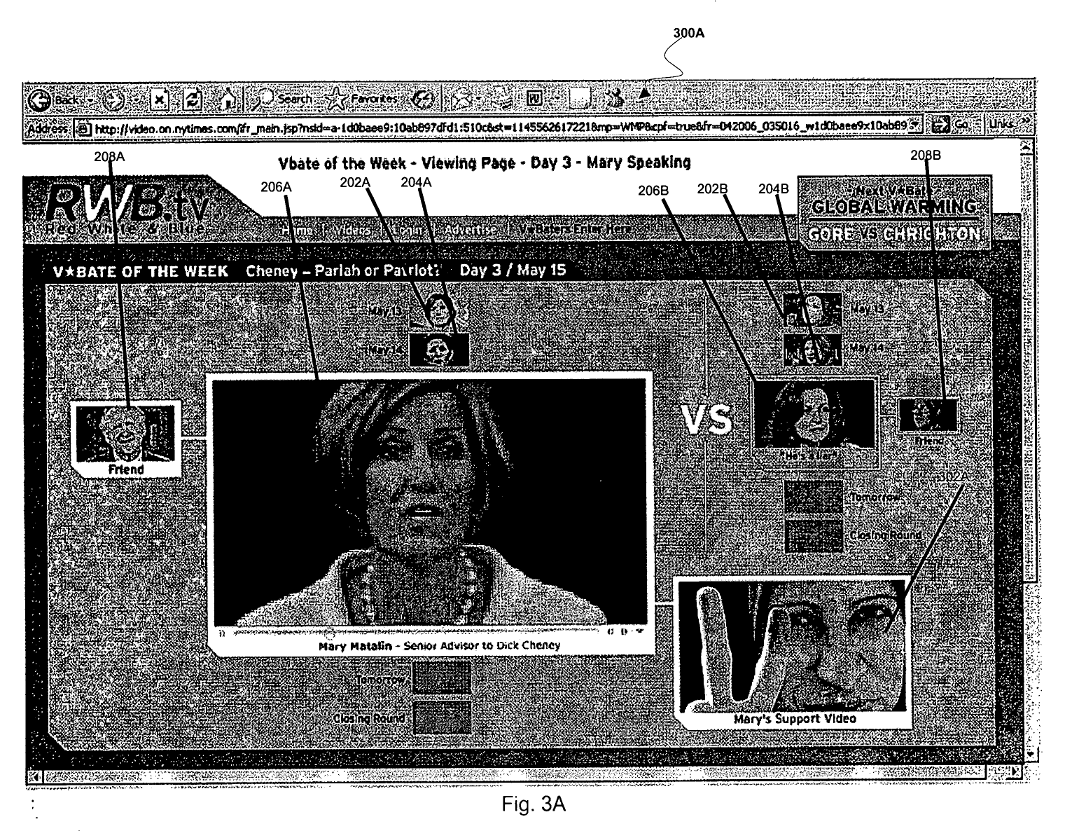

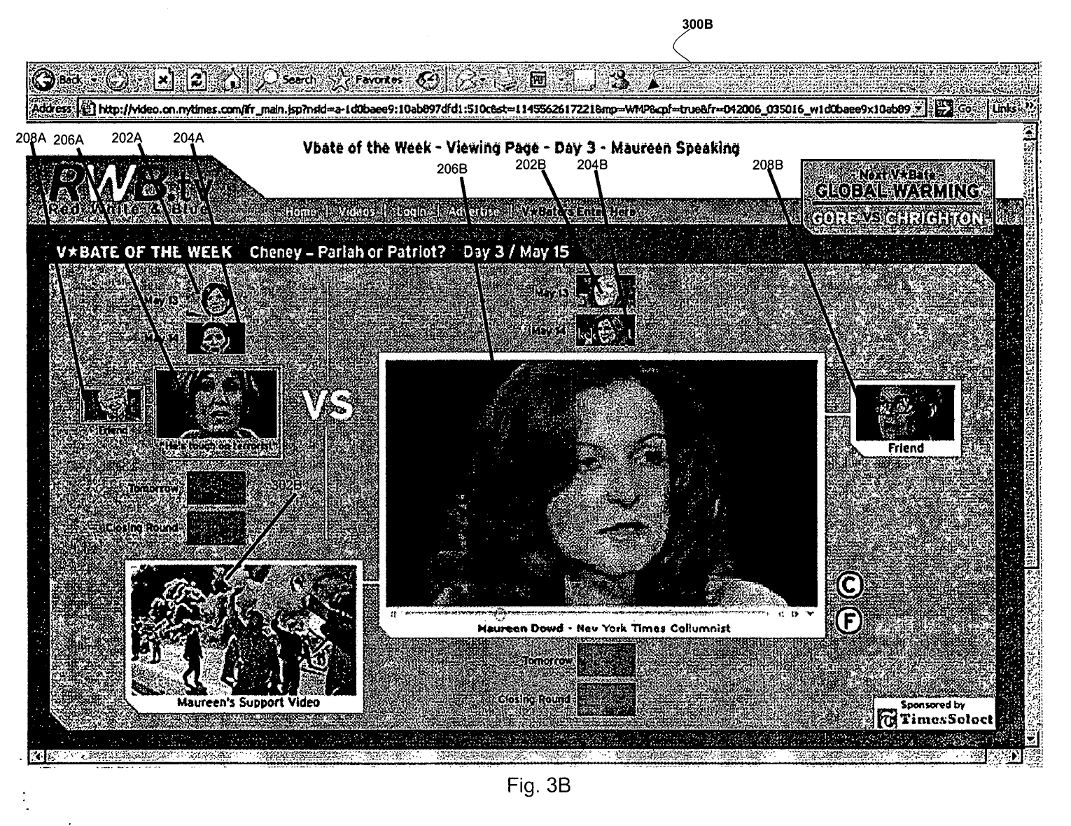

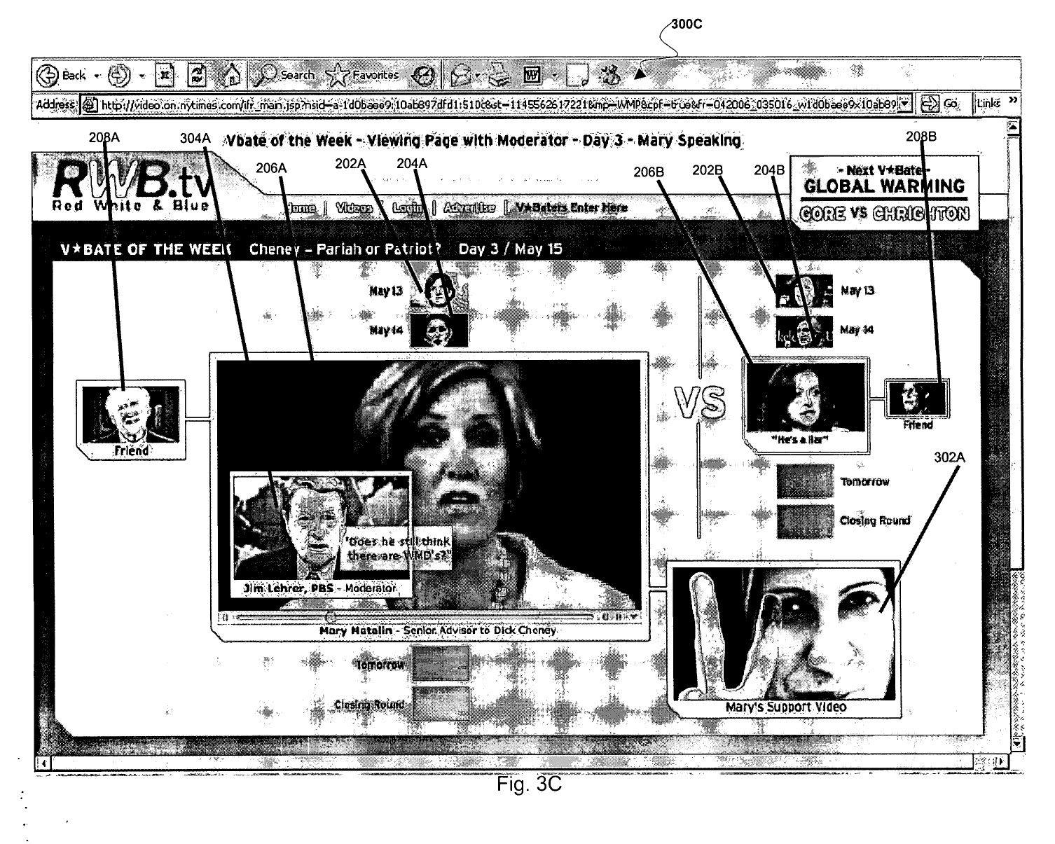

FIG. 3A illustrates an example display screen 300A that is provided to a viewer who had previously selected video segment 206A (FIG. 2). In the example shown in FIG. 3A, Mary Matalin's side of the debate is presented. Also provided are media selections 202A and 204A, as well as 202B, 204B and 206B for a user to select a different debate round for one of the respective debaters. Moreover, friend of the debate 208A/208B is selectable for the user to view a segment from a respective friend of the debate. Also shown in FIG. 3A is supporting video segment 302A that is provided by the selected debater and respective round (206A).

FIG. 3B illustrates an example display screen 300B that is provided to a viewer who had previously selected video segment 206B (FIG. 2). In the example shown in FIG. 3B, Maureen Dowd's side of the debate is presented. Also provided are media selections 202B and 204B, as well as 202A, 204A and 206A for a user to select a different debate round for one of the respective debaters. Moreover, friend of the debate 208B/208A is selectable for the user to view a segment from a respective friend of the debate. Also shown in FIG. 3B is supporting video segment 302B that is provided by the selected debater and respective round (206B).

FIG. 3C illustrates an example display screen 300C that includes a moderator 304A and that is provided to a viewer who had previously selected video segment 206A (FIG. 2). In the example shown in FIG. 3C, Mary Matalin's side of the debate is presented, and Jim Lehrer of PBS is the shown moderator 304A. Similar to FIG. 3A, also provided are media selections 202A and 204A, as well as 202B, 204B and 206B for a user to select a different debate round for one of the respective debaters. Moreover, friend of the debate 208A/208B is selectable for the user to view a segment from a respective friend of the debate. Also shown in FIG. 3C is supporting video segment 302A that is provided by the selected debater and respective round (206A). In a preferred embodiment, moderator 304A is presented in various display screens, such as in display screen 300B.

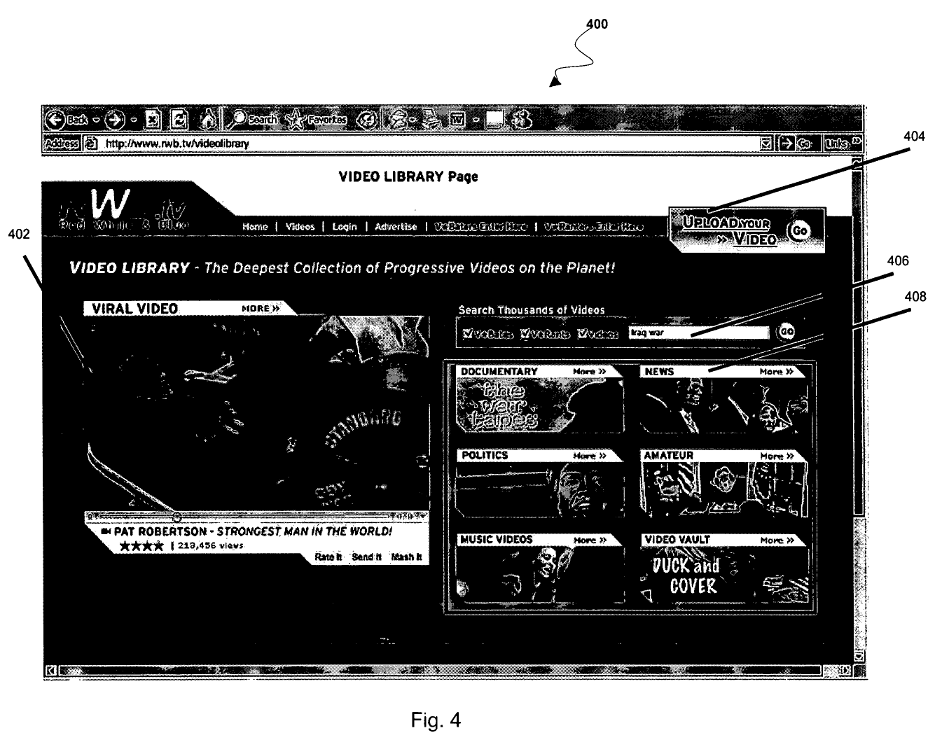

FIG. 4 shows an example display screen 400 that is provided to a user who selects video library section 114 (FIG. 1). Example display screen 400 includes a selected video 402 that was selected by the user. Further, upload video control 404 is provided for users to upload video content, such as a MPEG file or the like. Further, search control 406 is provided for a user to locate a particular video, for example, that has associated metadata. Additionally, video category section 408 includes selectable icons of respective video categories for users to browse various kinds of video content, such as documentaries, news, politics, amateur, music videos and archives.

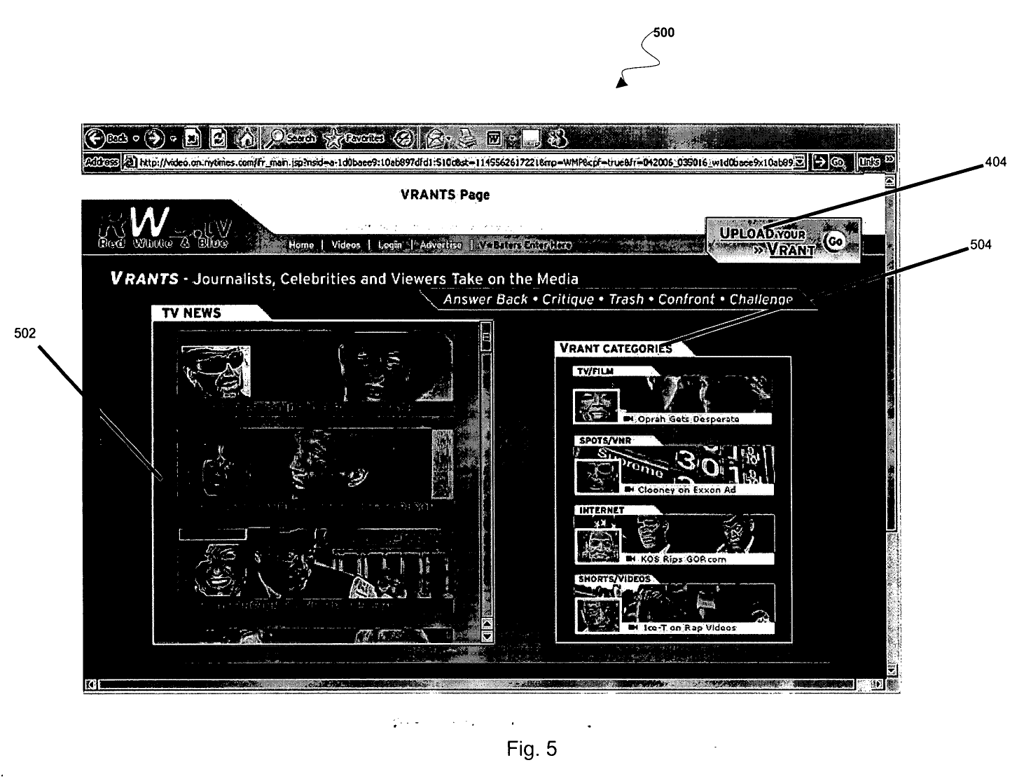

FIG. 5 shows an example display screen 500 that is provided to a user who selects video library data archive 112 (FIG. 1). Example display screen 500 includes video selection section 502 that includes various video content provided in connection with a selected category associated with video category section 408 (FIG. 4). In section 502, television news video content is provided. Further, category section 504 provides additional categorized sources of video content, including TV/Film, sports, internet, and short videos.

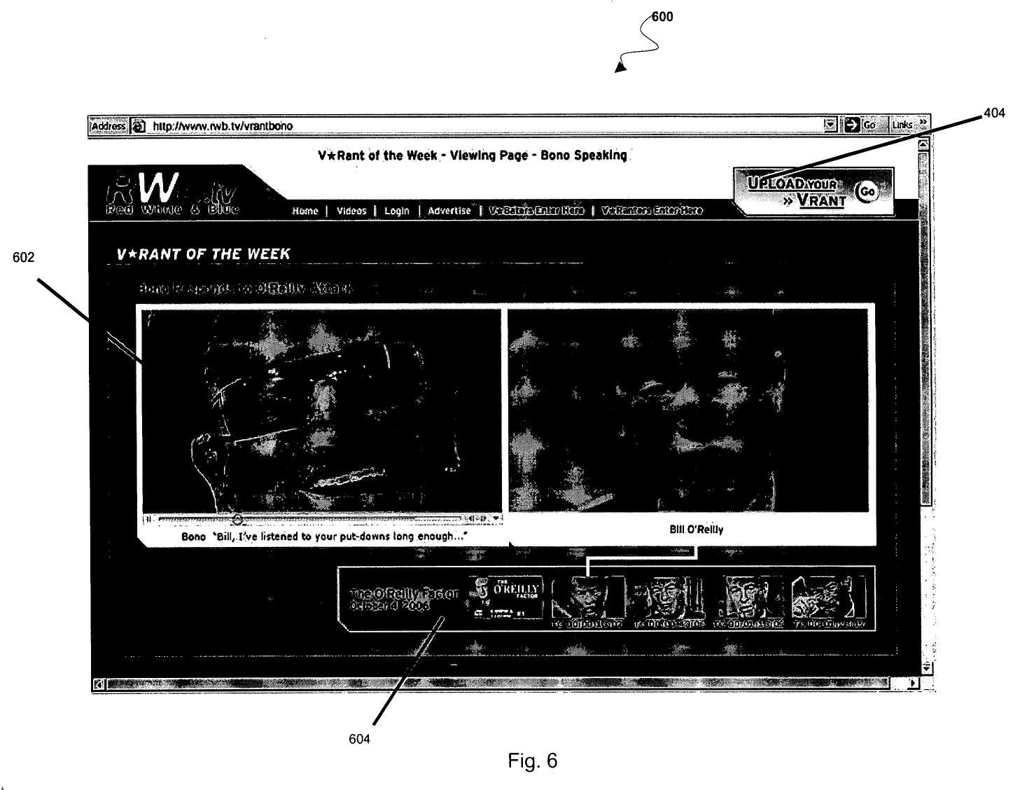

FIG. 6 shows an example display screen 600 that is provided to a user who selects respective video content in video selection section 502 (FIG. 5). Example display screen 600 includes a selected video 602 that was selected by the user that includes the musician Bono with the television personality, Bill O'Reilly. Preferably, section 602 does not display a debate in accordance with the teachings herein, but instead displays archived video content. Also and as shown and described with reference to FIGS. 4 and 5, upload video control 404 is provided for users to upload video content. Further, video section selector 604 is provided for a user to locate a particular time period within the video 602, for example, identified by a respective time code.

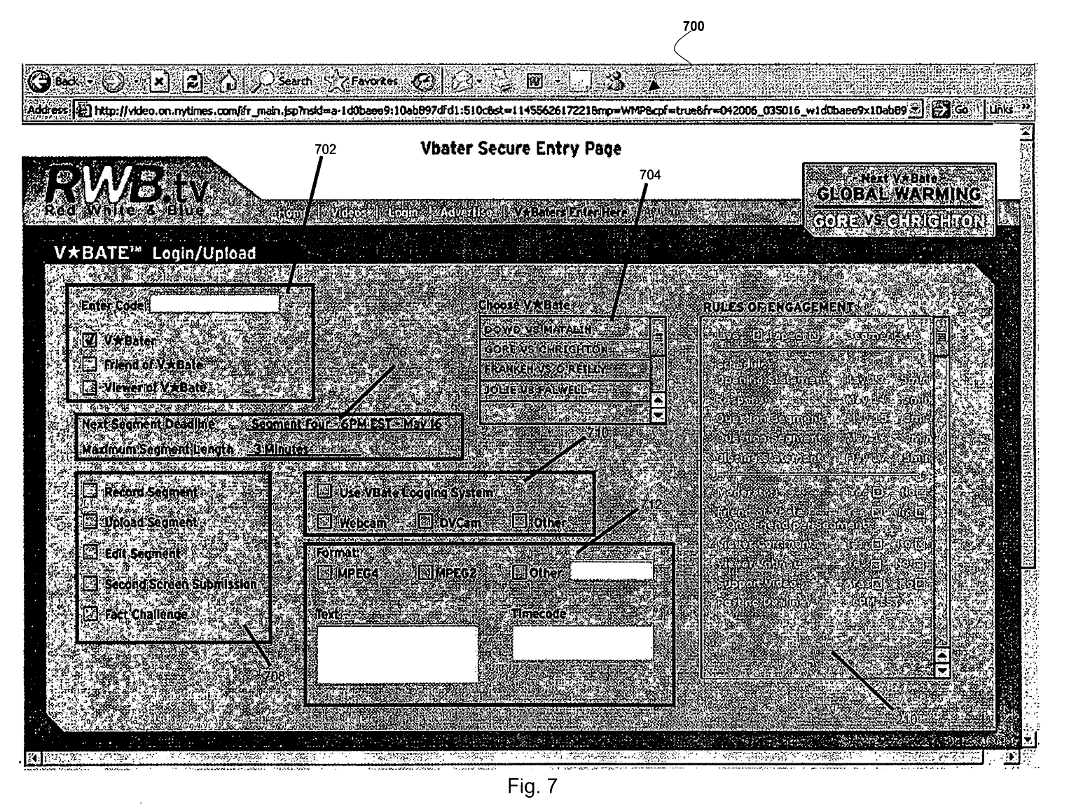

FIG. 7 illustrates an example data entry form 700 that is provided to registered or otherwise authorized users who desire to submit media content in accordance with the teachings herein. As shown in FIG. 7, login section 702 includes a textbox for a user to submit an authorization code to submit a video segment or otherwise participate in a debate. In section 702, the user selects checkbox controls to identify himself as a debater (displayed in FIG. 7 as “V*Bater”), a friend of the debate (displayed in FIG. 7 as “Friend of V*Bater”) and/or a viewer of a debate (displayed in FIG. 7 as “Viewer of V*Bater”).

After a user submits proper authorization to participate in a debate, the user makes a selection in video debate section 704 to select a respective debate. In example display screen 704 shown in FIG. 7, the user is presented with a list box, from which the user selects a respective debate. Once the user selects a debate, information regarding segments is preferably displayed in section 706 that, for example, includes the date of video segment deadline, and the maximum length of a video segment.

In action section 708, the user selects one or more checkbox controls to identify the particular participation the user will make. For example, the user selects options to record a video segment, upload a video segment, edit a video segment, make a second screen submission and/or present a factual challenge. In section 710, the user selects one or more checkbox controls to define the respective technology the user will use. For example, the user selects options for using a video logging system provided by a web site providing debates in accordance with the teachings herein, a webcam, a dvcam, or some other technology. Further, in format section 712 the user selects a respective video format, as well as accompanying text and a timecode for the respective video. Also, once the user selects a debate, the respective rules of engagement section 210 is presented as a reference for the user.

Thus, using the controls shown in example display screen 700, a user can participate in a debate in a direct or indirect manner.

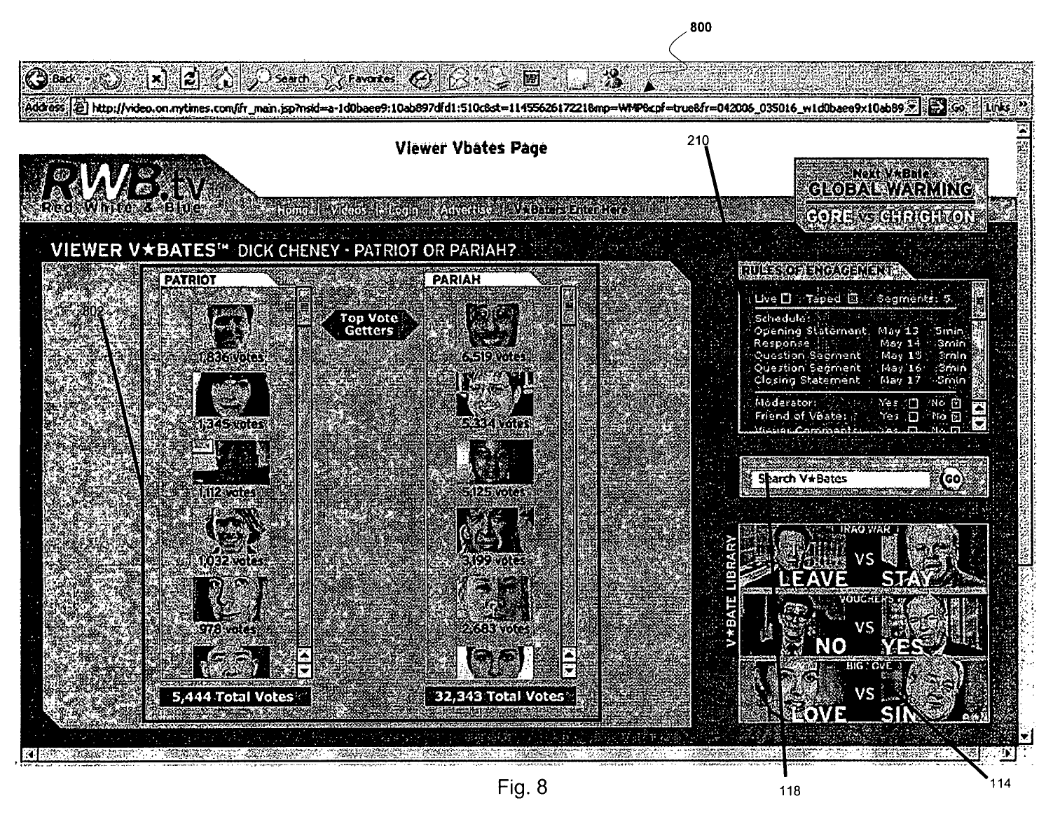

FIG. 8 illustrates an example display screen 800 that is provided to a user for reviewing tabulated vote counts associated with a respective video debate. In the example shown in display screen 800, two columns of images representing participants in a video debate are displayed in section 802, and ranked according to the number of votes each respective participant received from viewers. Each column in section 802 represents a respective side in a debate, and each image represents a participant, such as a friend of the debate, a person who submitted commentary or other participant who contributed, for example, via the selections shown in example display screen 700 (FIG. 7). Search box 118 is also provided in display screen 800 for a user to locate a respective video debate and review tabulated votes received by various participants. Moreover, rules of engagement section 210 is displayed as a reference for the user in accordance with a selected debate. Video library section 114 is also preferably provided in display screen 800 for a user to select other debates and/or features described herein.

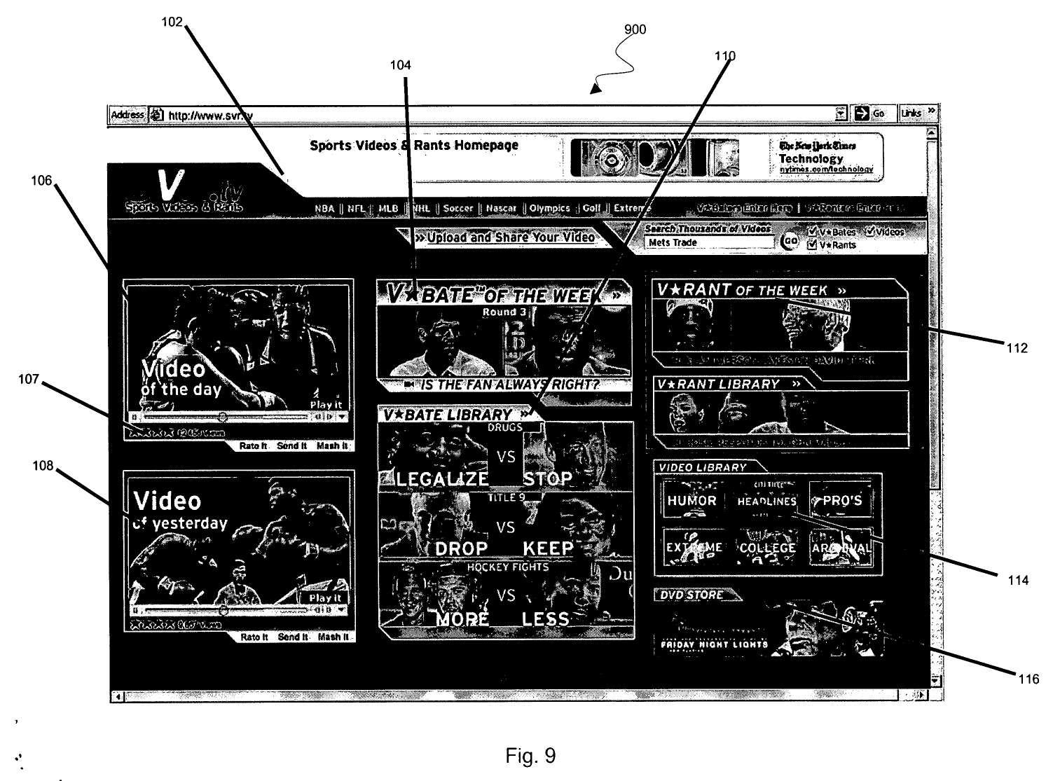

Although many of the examples described herein relate to debates that are political in nature, one skilled in the art will recognize that debates of countless topics are supported by the teachings herein. FIG. 9 illustrates an alternative example internet home page 900 in connection with debates associated with sports content. In the example shown in FIG. 9, display sections 102-116 (FIG. 1) are illustrated, however the content is directed to sports (e.g., boxing), as opposed to political debate. Thus, and as shown in the example display screen 900, the systems and methods described herein are applicable to many topics and appeal to many different kinds of people.

Therefore and as will become evident to one skilled in the art, various display screens are provided, for example, over the internet for users to view and/or participate in debates according to the teachings herein. In addition to viewing and/or participating in a debate, users can make selections to view archived video, to purchase video, and/or to submit video.

A discussion of example rules and elements of a debate, as well as various formats supported by the teachings herein is provided below in connection with a preferred embodiment.

Preferably, video debates include an opening segment in which each participant preferably records or otherwise submits an opening statement. In an embodiment, each opening statement is limited to a five-minute duration. Also preferably, opening statements are posted no later than 9:00 p.m. EST, the day prior to the beginning of the debate. Moreover, the opening statements are preferably available for viewing by 9:00 a.m. the morning of a debate.

Once opening statements are available for viewing, each debater preferably has opportunities to post second, third and fourth video segments, each within twenty-four hour periods, and each of which are preferably available for viewing the following day after being posted. Each debater preferably agrees to pose a question of another debater at the end of each submitted video segment. Further, the text of the questions are preferably posted on the host site along with each video segment and a friend of the debate segment.

On the fifth day of a debate, each debater preferably provides a final closing statement video segment. Each closing statement preferably is limited to a seven-minute duration, for example, according to the rules of engagement as displayed in section 110.

Further, each debater preferably is provided with an opportunity to record five, individual one-minute challenges to specific factual claims or statements made by an opposing video debater. Preferably, the challenges are tagged, as known in the art, o a specific moment in the opposing debater's statements.

Preferably, entire debates or individual segments of a debate may be provided as a live debate, substantially in real time. A debate may originate on a host web site as a webcast, or, alternatively, on a cable or satellite transmission that is later enhanced or adapted to for archiving and replay according to the teachings described herein.

Preferably, an internet web site that provides debates in accordance with the teachings herein in can utilize features to record and provide commentary on third party media. This third party media can either be recorded and organized or recorded and posted by a third party. Users can submit video segments that feature media analysis and criticism. The Commentary System simply replaces one “side” of the debate with a segment of existing third party media. Moreover, third-party commentary can be provided on existing video media including but not limited to television news, commercials, feature films, television shows, web sites, shorts, documentaries, corporate productions, public service announcements, video news releases, government films, music videos, shorts, podcasts, amateur films etc.

In an embodiment that includes a display screen, which is divided into a right-hand portion and a left-hand portion, the left-hand portion may be, for example, be displaying a particular segment of existing media that a commentator will record a video segment and, preferably, comment on.

Users are preferably able to record hundreds of hours of content that may have been provided on television, the internet or other sources. Preferably, a monitoring system is integrated to allow commentators to accurately record, ingest, edit and post their own video commentary segments. Such commentary segments are preferably linked to specific segments of third party media of their choice. Thus, in case third party content is not recorded by a party providing commentary, a pre-recorded copy of content from a third party source can be provided.

A description of an example debate in accordance with the teachings herein is provided below.

A known political pundit, Party A, comments on specific remarks by another pundit, Party B, on a known news network. Party A selects an option to provide commentary and uses a pre-approved access code that represents Party A as a pre-approved media commentator on a web site providing a debate in accordance with the teachings herein. Party A enters search terms in a search text box to search for a respective video segment he wants to comment on. Party A find the segment on-line and “tags” an in-point and out-points of the exact location of the Party B video segment he chooses to retort.

Continuing with the above-example, Party A records his video comments or uploads pre-recorded video comments and edits that segment using editing features provided herein. In practice, Party A has more than one Party B video segment he wishes to comment on, and, accordingly, repeats the process until he has recorded the segments he desires. In a preferred embodiment, multiple comments of any length are accommodated. Once submitted, Party A previews or otherwise reviews the segment for posting on a particular host site. Searchable metadata is preferably by Party A or other third parties or loggers. Thereafter, Party B's video segments and Party A's video commentary segments are available for sequential playback, for example, by selecting hyperlinks.

Party B records and posts his own refutations of Party A's commentary segments and Party B's comments are linked, as well.

In another embodiment, long format video content can be easily divided into shorter segments that are currently more easily delivered and viewed in the new and emerging digital mediums.

Preferably other features are envisioned herein for accepting, reviewing, approving and posting video submissions. An online system is preferably provided that allows content suppliers the ability to sell to or agree to let a host of a web site providing a debate in accordance with the teachings herein to represent them on a non-exclusive or exclusive basis their submitted content, or divide and segment content for syndication or delivery to a third party for sale, subscription or syndication.

Preferably, video is archived, converted, digitized, recorded, hosted and/or streamed. Moreover, filmmakers and content owners can authorize content they own to be divided into segments or, alternatively, to have content shown in its entirety.

Preferably, sites will host lively and provocative debates recorded “virtually” by invited web pundits, journalists and experts. These submissions are preferably linked chronologically according to mutually agreed upon rules of the debate by the parties of the debate. Preferably, a range of options for length of segments, live vs. recorded, time of submission etc., as described above, are accommodated.

In an example embodiment, revenue is generated by traditional banner ads and the video advertisements that precede, follow, or interrupt video segments on a host site. New advertising alternatives to traditional television commercials will preferably be further supported and utilized to maximize revenues for sites utilizing the features and teachings herein. Current technology allows advertisements to be targeted to specific moving image segment topics. Further, existing third party services that host and serve video, coordinate advertising and subscription models may also be engaged.

The present invention may be used for political debate, but can be utilized for debate and commentary on any topic including but not limited to sports, business, entertainment, celebrity, music, art, science, religion, technology, military, ethics, morality, sex, psychology, etc.,

Moreover, various features, such as a current video debate of the week, video of the day, video of yesterday, DVD of the day may be featured. FLASH technology and other new technologies will be employed for easy and quick viewing of new and archival footage on the home page and throughout the site.

DVD's and other media will be promoted and sold on the site and video segments and highlights from currently available titles and new releases will be featured.

In an example web site, commentary on recent media in a variety of media categories will be presented on the home page. An emphasis is preferably placed on news and commentary on television shows and web sites.

Further, features of the present invention, including the ability to provide commentary preferably accommodate the ability to add metadata to any video segment using existing or proprietary technology for logging by in-house or remote staff of a host site or to utilize voice recognition technology or other future technologies for logging and metadata.

Thus, a scalable system is provided to store a growing library of moving image content. All video debates are preferably archived.

Additional features of the present invention include aggregating video content, building a community around video content, video logs (“vlogs”), webcasts and video commentary and accommodating revenue through targeted advertising and DVD sales. This enables business software that tracks and accommodates various on-line revenue models, customer tracking and retention software, micropayments, subscription services and the like.

The present invention provides a useful and unique system that creates a sort of “hub” for the best in spirited video debates or “Vbates” on the lightning-rod topics of the day and will facilitate host sites in building vibrant web communities around the subjects of their choice. The System will help facilitate parallel revenue streams in advertising, subscription and merchandise sales and help sites achieve profitability.

Preferably, compression and streaming technology are used to present video content in an easy to navigate, issue-oriented format. Video preferably plays instantly and leads the viewer fluidly to other video content on the same topic. Any internet web site utilizing the features and teachings herein, and that may host content attracts content providers, encourages debate, generates advertising and promotes sales.

Further the present invention preferably provides for free and low cost third party content. Producers of political content are advocates and want their films seen. The content is often free. A good deal of archival material is in the public domain. Producers of issue-oriented content want to fuel DVD sales. Amateurs need exposure and will readily provide material. Accordingly, the present invention preferably facilitates and encourages digging into the “vaults” and unearthing influential political shorts, commercials, and documentaries of the past. For many viewers, the system will facilitate a first-time exposure to some of the most powerful film ever produced. Thus, a pipeline of low cost, often-free content ensures profitability and comprehensive, provocative and engaging web sites.

Further, the a low cost infrastructure is preferably employed via improved broadband transmission, open source software, bit torrent, RSS, cheaper digital storage and low-cost production tools. These advances have created a compelling financial model for the creation and distribution of video content.

For example, each election cycle dwarfs the past one in cost, commitment, technology and frenzy. Ideological battles are increasingly played out on the web, with sophisticated media weapons. A Supreme Court nominee, an impending Congressional vote, a visiting head of state, can spark millions in partisan advertising and the creation of scores of shorts, animations and documentaries. The present invention preferably presents and enables a user to navigate a seemingly endless source of original, low cost and compelling content.

Although the present invention has been described in relation to particular embodiments thereof, many other variations and modifications and other uses will become apparent to those skilled in the art. For example, features such as closed captioning, voice recognition, logging and/or translation may be applied to debates. Further, various data transmission formats may be provided, such as XML and/or RSS, as known in the art. It is preferred, therefore, that the present invention not be limited by the specific disclosure herein.

What is claimed is:

1. A method for electronically providing a debate of at least two viewpoints, the method comprising:
defining at least a first party having a first viewpoint and a second party having a second viewpoint, wherein the first party and the second party participate in the debate;
defining rules of the debate that the at least first party and second party agree to follow for the debate;
receiving from the first party a first electronic transmission representing the first viewpoint;
receiving from the second party a second electronic transmission representing the second viewpoint;
electronically enforcing the rules of the debate with respect to the first electronic transmission and the second electronic transmission, and modifying at least one of the transmissions if the at least one of the transmissions does not comply with the rules of the debate; and
electronically receiving from a third party a third electronic transmission that represents at least one selected from the group consisting of factual challenge, multimedia content supporting the first viewpoint or the second viewpoint, and commentary, wherein the first, second and third electronic transmissions are accessible to viewers over a communication network.

2. The method of claim 1, further comprising posting the first, second and third transmissions on an internet web site.

3. The method of claim 1, further comprising providing archived video content for the viewers.

4. The method of claim 3, further comprising storing the archived video content in a database.

5. The method of claim 1, further comprising providing multimedia content to the viewers, wherein the multimedia content is unrelated to the debate.

6. The method of claim 1, further comprising storing the first, second and third transmissions in a database.

7. The method of claim 6, further comprising providing access to the stored first, second and third transmissions to a viewer.

8. The method of claim 1, further comprising electronically receiving votes from the viewers, wherein the votes represent each respective viewer's opinion of the winner of the debate.

9. The method of claim 8, further comprising awarding a prize to the party that wins the most votes.

10. The method of claim 1, wherein the first transmission or the second transmission is recorded, uploaded, e-mailed or mailed.

11. The method of claim 1, further comprising receiving from the first party a fourth electronic transmission further representing the first viewpoint and receiving from the second party a fifth electronic transmission further representing the second viewpoint.

12. The method of claim 1, further comprising organizing the first, second and third transmissions as a function of the rules of the debate.

13. The method of claim 1, further comprising reviewing by the first party, the second party, the third party or a fourth party the first transmission, the second transmission or the third transmission.

14. The method of claim 1, further comprising translating the first transmission or the second transmission from a first spoken language to a second spoken language.

15. The method of claim 1, further comprising defining metadata for the first transmission, the second transmission or the third transmission.

16. The method of claim 1, further comprising enabling advertisers to couple or link multimedia content with the first transmission or the second transmission.

17. The method of claim 1, wherein the first party or the second party is sponsored.

18. A system for electronically providing a debate of at least two viewpoints, the system comprising:
a database accessible over a communication network;
at least a first party having a first viewpoint and a second party having a second viewpoint, wherein the first party and the second party participate in the debate and are registered in the database;
a first electronic transmission received from the first party, wherein the first electronic transmission represents the first viewpoint;
a second electronic transmission received from the second party, wherein the second electronic transmission represents the second viewpoint;
rules of the debate that are electronically stored in the database, wherein the at least first party and the second party agree to follow the rules of the debate, wherein the rules are electronically enforced with respect to the first electronic transmission and the second electronic transmission, and at least one of the transmissions is modified if the at least one of the transmissions does not comply with the rules of the debate; and
a third electronic transmission received from a third party that represents at least one selected from the group consisting of factual challenge, multimedia content supporting the first viewpoint or the second viewpoint, and commentary, wherein the first, second and third electronic transmissions are accessible to viewers over the communication network.

19. The system of claim 18, further comprising an internet web site on which the first, second and third transmissions are posted.

20. The system of claim 19, further comprising archived video content that is provided for the viewers.

21. The system of claim 20, wherein the archived video content is stored in the database.

22. The system of claim 18, further comprising multimedia content that is unrelated to the debate and provided to the viewers.

23. The system of claim 18, wherein the first, second and third transmissions are stored in the database.

24. The system of claim 23, wherein the stored first, second and third transmissions are accessible to the viewers.

25. The system of claim 18, further comprising votes received from the viewers, wherein the votes represent each respective viewer's opinion of the winner of the debate.

26. The system of claim 25, further comprising a prize awarded to the party that wins the most votes.

27. The system of claim 18, wherein the first transmission or the second transmission is recorded, uploaded, e-mailed or mailed.

28. The system of claim 18, further comprising a fourth electronic transmission further representing the first viewpoint received from the first party and a fifth electronic transmission further representing the second viewpoint received from the second party.

29. The system of claim 18, wherein the first, second and third transmissions are organized for the viewers as a function of the rules of the debate.

30. The system of claim 18, wherein the first party, the second party, the third party or a fourth party review the first transmission, the second transmission or the third transmission.

31. The system of claim 18, further comprising a translation of the first transmission or the second transmission from a first spoken language to a second spoken language.

32. The system of claim 18, further comprising metadata defined for the first transmission, the second transmission or the third transmission.

33. The system of claim 18, further comprising advertisements coupled to or linked to the first transmission or the second transmission.
